(19) United States
(12) Patent Application Publication
(10) Pub. No.: US 2025/0341716 A1
(43) Pub. Date: Nov. 6, 2025

(54) APPARATUS, SYSTEM, AND METHOD FOR INTEGRATING EYE-TRACKING COMPONENTS WITHIN DISPLAY ASSEMBLIES

(71) Applicant: Meta Platforms Technologies, LLC, Menlo Park, CA (US)

(72) Inventors: Mantas Zurauskas, Redmond, WA (US); Pavel Trochtchanovitch, Shoreline, WA (US); Catherine Fromm, Seattle, WA (US); Dilraj Singh Devgun, New York, NY (US); Christopher Aholt, Newcastle, WA (US); Jonathan Battershell, Bothell, WA (US); Sebastian Sztuk, Virum (DK); Yimin Ding, Kirkland, WA (US); Anthony Diego Draper, Sammamish, WA (US); Jo Anne Etter, Stillwater, MN (US); Mohamed Tarek Ahmed El-Haddad, Redmond, WA (US); Alexander Jobe Fix, Seattle, WA (US); Robert Dale Cavin, Bellevue, WA (US)

(21) Appl. No.: 19/199,447

(22) Filed: May 6, 2025

Related U.S. Application Data
(60) Provisional application No. 63/643,134, filed on May 6, 2024.

(51) Int. Cl. G02B 27/00; G02B 6/42; G02B 27/01; G06F 3/01; H04N 13/239; H04N 13/383

(52) U.S. Cl. CPC G02B 27/0093; G02B 6/4204; G02B 27/0172; G02B 27/0179; G06F 3/013; G02B 2027/0138; G02B 2027/0178; G02B 2027/0187; H04N 13/239; H04N 13/383

(57) ABSTRACT

An eyewear device comprising (1) a display assembly configured to generate graphical imagery for viewing by a user, (2) an eye-tracking device at least partially integrated into the display assembly, and (3) circuitry communicatively coupled to the eye-tracking device and configured to track an eye of the user based at least in part on light detected by the eye-tracking device. Various other apparatuses, systems, and methods are also disclosed.

### PRIORITY CLAIM

This application claims the benefit of U.S. Provisional Application No. 63/643,134 filed May 6, 2024, the disclosure of which is incorporated in its entirety by this reference.

### BRIEF DESCRIPTION OF DRAWINGS

The accompanying drawings illustrate a number of example embodiments and are a part of the specification. Together with the following description, these drawings demonstrate and explain various principles of the instant disclosure.

FIG. 1 is an illustration of an exemplary eyewear device equipped with one or more eye-tracking components integrated within a display assembly according to one or more implementations of this disclosure.

FIG. 2 is an illustration of an exemplary eyewear device for integrating eye-tracking components within display assemblies according to one or more implementations of this disclosure.

FIG. 3 is an illustration of an exemplary implementation of a display assembly with integrated eye-tracking components according to one or more embodiments of this disclosure.

FIG. 4 is an illustration of an exemplary implementation of a display assembly with integrated eye-tracking components according to one or more embodiments of this disclosure.

FIG. 5 is an illustration of an exemplary implementation of a display assembly with integrated eye-tracking components according to one or more embodiments of this disclosure.

FIG. 6 is a flow diagram of an exemplary method for integrating eye-tracking components within display assemblies according to one or more implementations of this disclosure.

FIG. 7 is an illustration of exemplary augmented-reality glasses that may be used in connection with one or more implementations of this disclosure.

FIG. 8 is an illustration of an exemplary virtual-reality headset that may be used in connection with one or more implementations of this disclosure.

FIG. 9 an illustration of an exemplary system that incorporates an eye-tracking subsystem capable of tracking a user's eye(s).

FIG. 10 is a more detailed illustration of various aspects of the eye-tracking subsystem illustrated in FIG. 9.

While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION OF EXEMPLARY EMBODIMENTS

The present disclosure is generally directed to apparatuses, systems, and methods for integrating eye-tracking components within display assemblies. As will be explained in greater detail below, these apparatuses, systems, and methods may provide numerous features and benefits.

Current eye-tracking techniques are often incorporated into different types of eyewear devices, such as head-mounted displays (HMDs). For example, these techniques typically include physical components that observe a viewer's eye movement to determine what the viewer is looking at within a display. In some implementations, these components may include one or more lights that shine onto the viewer's eyes and one or more optical sensors (e.g., cameras) that observe how the one or more lights are reflected by the viewer's eyes.

In some examples, a user may wear and/or don an HMD equipped with eye-tracking technology. In one example, occlusion may impair and/or harm the eye-tracking technology from accurately monitoring, sensing, and/or tracking the user's eyes. In this example, the occlusion may prevent the eye-tracking technology from achieving a sufficient view of the user's eyes.

In some examples, the systems disclosed herein may mitigate and/or eliminate the problem of occlusion by integrating at least some of the eye-tracking components (e.g., light sensors and/or cameras) into a display assembly of an HMD worn by a user. For example, an HMD may include and/or represent a camera that is integrated into the conjugate optical plane of the light source for the display assembly. In one example, conjugate optical planes may constitute and/or represent optically equivalent planes relative to the eye. In this example, such conjugate optical planes may ensure proper alignment between display pixels and the eye-tracking sensors.

In one example, the eye-tracking components may be integrated into and/or optical coupled to the display panel and/or waveguide. In certain implementations, such integration of such eye-tracking components may mitigate and/or eliminate occlusion because, if the user is able to see the display pixels and/or rasterized graphical imagery, then the eye-tracking components are able to see relevant portions of the user's eye like the pupil, retina, sclera, etc.

In some examples, the HMD may include and/or apply a waveguide-imaging path used to image and/or map the pupil plane from the same angle as the visual display projected and/or presented for viewing by the user. In one example, the HMD may rely on the waveguide-imaging path to perform infield measurements by placing virtual cameras closer to the optimal position in the user's view. Additionally or alternatively, the HMD may implement spatial multiplexing for capturing multiple views of one of the user's eye with the same sensor.

In some examples, the HMD may use and/or rely on the display and/or waveguide for both illumination and sensing along the same optical plane and/or path. For example, the HMD may implement both display illumination and eye tracking at the same angle as one another. In one example, the HMD may include and/or represent waveguide cameras with central field-of-view (FOV) rays aimed at the center of the eye box. Additionally or alternatively, photodetectors and/or cameras may be integrated in the display of the HMD to image the user's retinas. In certain implementations, the HMD may implement and/or emit collimated light from a waveguide display via pupil replication.

In some examples, the HMD may implement and/or rely on a waveguide that carries both the visible light used to produce graphical imagery for viewing by the user and invisible light used to image and/or map the user's eye for eye-tracking purposes. In one example, the waveguide may carry visible light and invisible light that travel in different directions relative to one another. In this example, the waveguide may be optically coupled to a display device that emits the visible light for display purposes and a camera that receives the invisible light for eye-tracking purposes. In certain implementations, the display device and the camera may be positioned and/or disposed along the same optical plane and/or along conjugate optical planes relative to one another.

In some examples, the HMD may integrate a waveguide camera and a mini camera in the field. In one example, the waveguide camera may be configured to receive light from the center of the eye box for retinal imaging. In this example, the mini camera may be configured to track pupil position and/or sclera position. Additionally or alternatively, one or both of these cameras may be used by the HMD to perform gaze tracking.

In some examples, the HMD may track the state, position, orientation, and/or movement of the eye or its features based at least in part on changes in the images of the eye captured by the camera(s). For example, the HMD may compare the images of the eye captured at different moments in time to one another. In this example, the HMD may identify and/or determine changes in the state, position, and/or orientation of the eye based at least in part on differences in the light patterns illuminating the eye across the images.

In some examples, the HMD may include and/or represent circuitry that identifies changes and/or features depicted in the plurality of images. Additionally or alternatively, the circuitry may determine at least one attribute (e.g., the state, position, movement, and/or orientation) of the eye based at least in part on the changes and/or features. In certain implementations, the circuitry may use and/or rely on pupil dilation and/or contraction metrics to modulate display parameters (e.g., brightness, contrast, or content complexity) in real time.

In some examples, the circuitry may track the eye's movement based at least in part on the attribute of the eye. In one example, the circuitry may perform one or more actions in response to the attribute of the eye. Examples of such actions include, without limitation, generating virtual content presented via optical elements (e.g., lenses), modifying virtual content presented via optical elements, initiating a telephone call, sending a text message or other communication, executing a computing command and/or instruction, predicting future gaze changes, combinations of one or more of the same, and/or any other suitable actions.

In some examples, the circuitry may include and/or represent one or more electrical and/or electronic circuits capable of processing, applying, modifying, transforming, displaying, transmitting, receiving, and/or executing data for the HMD. In one example, the circuitry may be electrically and/or communicatively coupled to the optical elements, collimated light source(s), coherent light source(s), lasers, camera(s), and/or optical sensor(s). In this example, the collimated light source and/or camera may each be integrated into and/or secured to the HMD and/or optical elements.

In some examples, the eye-tracking components that facilitate and/or support the eye tracking on the HMD may include and/or represent cameras, light sensors, light sources, optical modulators, phase shifters, optical switches, optical gates, light detection and ranging (LIDAR) devices, lasers, photodiodes, optical resonators, photonic crystals, light-emitting devices, combinations or variations of one or more of the same, and/or any other suitable components.

In some examples, the eyewear device may include and/or represent an HMD and/or an artificial-reality device or system. Artificial reality may provide a rich, immersive experience in which users are able to interact with virtual objects and/or environments in one way or another. In this context, artificial reality may constitute and/or represent a form of reality that has been altered by virtual objects for presentation to a user. Such artificial reality may include and/or represent virtual reality (VR), AR, mixed reality, hybrid reality, or some combination and/or variation of one or more of the same.

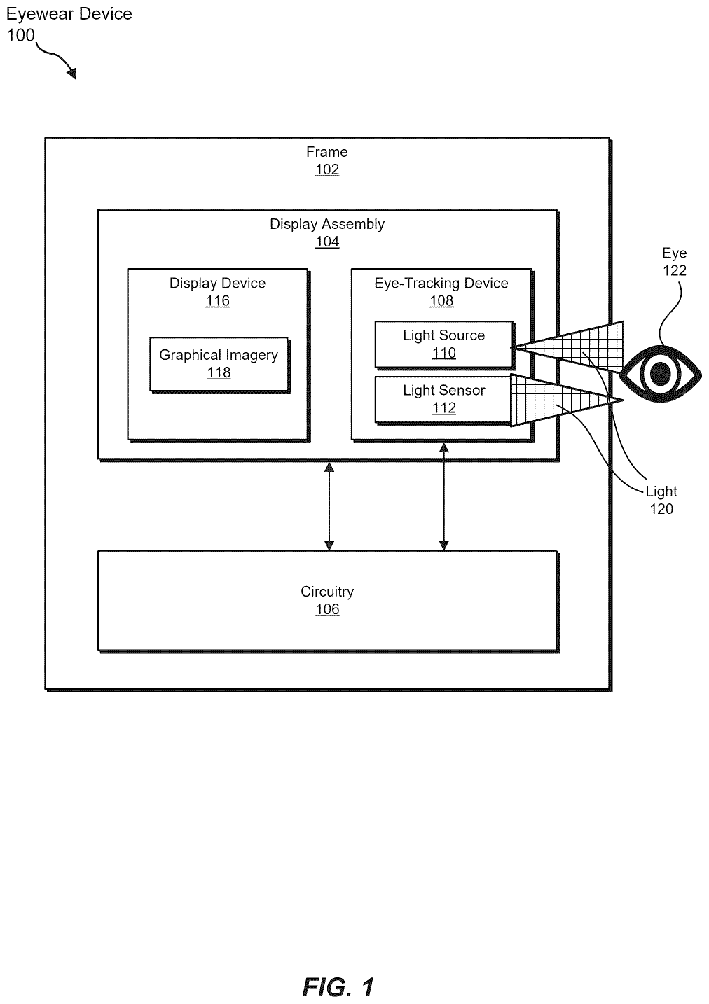

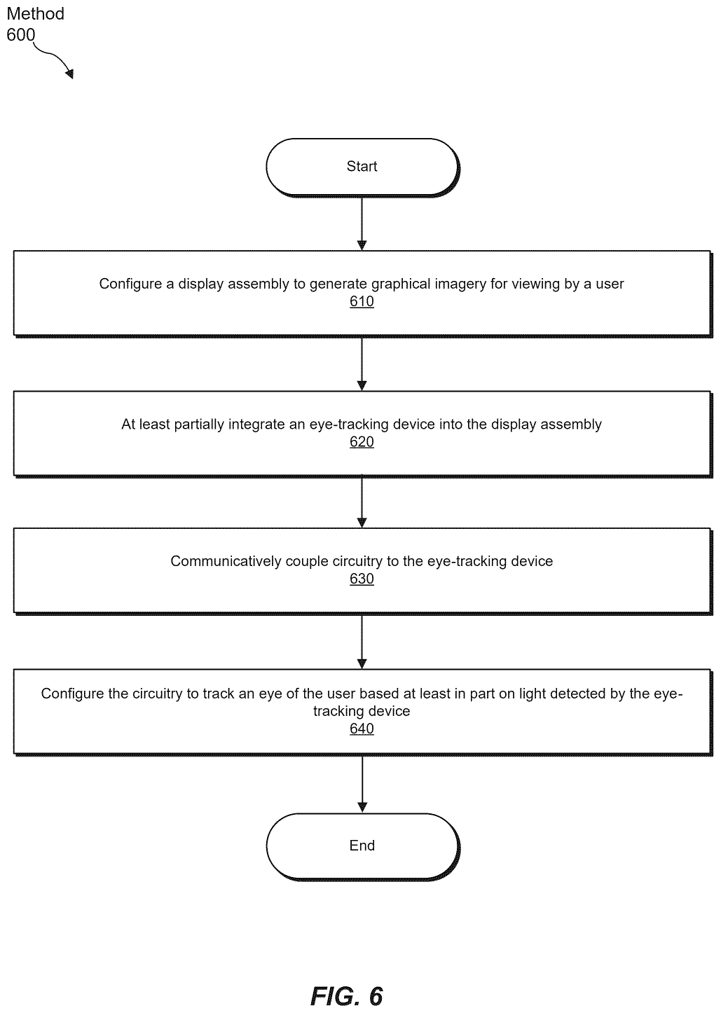

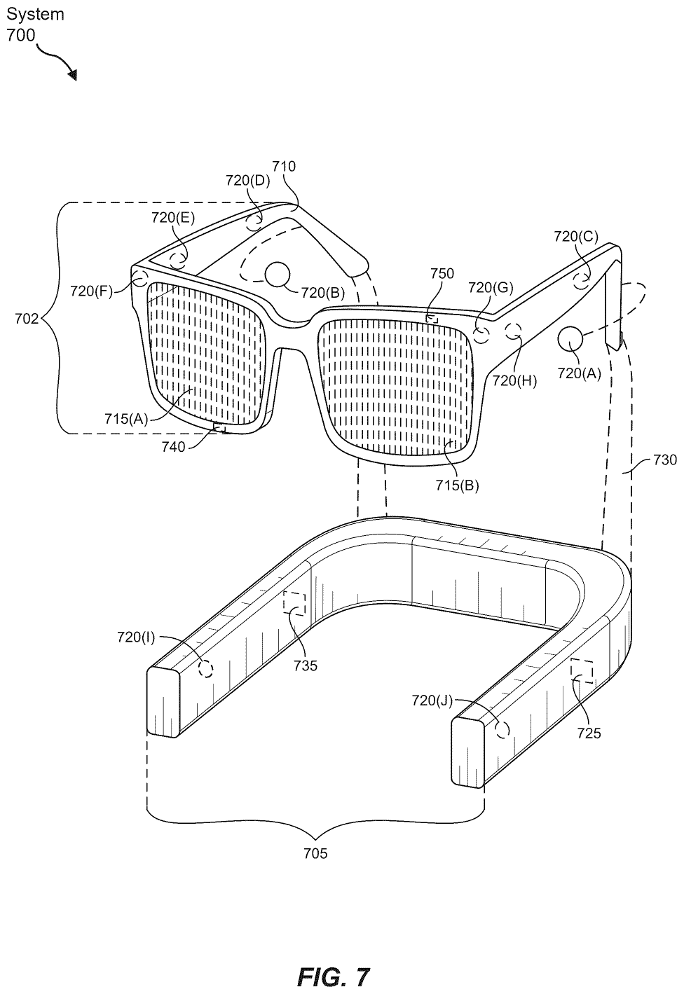

The following will provide, with reference to FIGS. 1-5, detailed descriptions of exemplary apparatuses, devices, systems, components, and corresponding configurations or implementations for integrating eye-tracking components within display assemblies. In addition, detailed descriptions of methods for integrating eye-tracking components within display assemblies will be provided in connection with FIG. 6. The discussion corresponding to FIGS. 7-10 will provide detailed descriptions of types of exemplary artificial-reality devices, wearables, and/or associated systems capable of steered retinal projection via movable cantilevered waveguides.

FIG. 1 illustrates an exemplary eyewear device 100 for integrating eye-tracking components within display assemblies. As illustrated in FIG. 1, eyewear device 100 may include and/or represent a frame 102 dimensioned to be worn by a user. In some examples, frame 102 may include and/or be equipped with a display assembly 104, an eye-tracking device 108, and/or circuitry 106. In one example, circuitry 106 may be communicatively coupled to eye-tracking device 108. In this example, circuitry 106 may image, map, and/or track an eye 122 of the user via eye-tracking device 108 based at least in part on light 120 detected by eye-tracking device 108.

In certain implementations, some or all of circuitry 106 may be integrated into and/or represent part of display assembly 104 and/or eye-tracking device 108. Additionally or alternatively, some or all of circuitry 106 may be constitute and/or represent one or more standalone or separate circuits that are communicatively coupled to display assembly 104 and/or eye-tracking device 108. In one example, display assembly 104 may generate and/or produce graphical imagery 118 for viewing by the user. In this example, display assembly 104 may include and/or represent a display device 116 and/or at least a portion of eye-tracking device 108.

In some examples, eye-tracking device 108 may receive, obtain, and/or collect light that has been reflected and/or bounced off eye 122 to facilitate imaging, mapping, and/or tracking the user's eye. For example, eye-tracking device 108 may include and/or represent a light source 110 that emits light 120 toward eye 122 and/or a light sensor 112 that receives light 120 after having been reflected off eye 122. In this example, eye-tracking device 108 may provide and/or deliver a digital representation of light 120 as received from eye 122 to circuitry 106 for imaging, mapping, and/or tracking eye 122. In certain implementations, eye-tracking device 108 may include and/or represent multiple cameras that collectively facilitate and/or perform stereo imaging of eye 122.

In some examples, eyewear device 100 may include and/or represent an HMD that presents and/or displays virtual content and/or graphical imagery 118 via display assembly 104. For example, display assembly 104 may include and/or represent a scanning display that rasterizes light emitted by display device 116 into graphical imagery 118 for viewing by the user. Examples of display assembly 104 include, without limitation, a scanning display, a raster display, a retinal scan display, a virtual retinal display, a retinal projector, a display screen or panel, a liquid crystal display (LCD), a light-emitting diode (LED) display, an organic LED (OLED) display, a microLED display, a plasma display, a projector, a cathode ray tube, an optical mixer, combinations or variations of one or more of the same, and/or any other suitable type of display.

In some examples, display assembly 104 may include and/or represent one or more waveguides that carry and/or direct the light and/or illumination used to generate and/or produce graphical imagery 118 from display device 116 to the user's eye. In one example, display assembly 104 may include and/or represent one or more optical elements such as optical stacks, lenses, and/or films. Additionally or alternatively, display device 116 may include and/or represent a light source that emits and/or outputs the light and/or illumination used to generate and/or produce graphical imagery 118.

In some examples, circuitry 106 and/or display assembly 104 may provide, support, and/or project calibration targets (e.g., laser dots) through the waveguide's holographic gratings directly onto the retina. In one example, circuitry 106 and/or display assembly 104 may correlate retinal reflection data and/or pupil position data with gaze direction to auto-calibrate the eye-tracking components and/or features of eyewear device 100 without manual user input. For example, circuitry 106 may execute and/or implement a multi-point calibration sequence by correlating retinal reflection data and/or pupil position data with gaze direction. In this example, such a calibration sequence may be performed as an in-factory pre-calibration using synthetic data and/or may be completed with fine-tuning once the user operates eyewear device 100. In some examples, eyewear device 100 may include and/or represent a scanning display that facilitates presenting videos, photos, and/or computer-generated imagery (CGI) to the user. In one example, eyewear device 100 may include and/or incorporate see-through lenses that enable the user to see the user's surroundings in addition to such CGI. In this example, the scanning display may include and/or represent display components that vibrate light in resonance at approximately 25-30 kilohertz to facilitate generate and/or produce graphical imagery 118 for eyewear device 100.

In some examples, light source 110 and/or display device 116 may each include and/or represent any type or form of device capable of emitting, outputting, and/or producing light and/or electromagnetic radiation. In one example, light source 110 and/or display device 116 may each emit, produce, and/or generate coherent and/or collimated light. In another example, display device 116 may emit, produce, and/or generate visible light for graphical imagery 118, and light source 110 may emit, produce, and/or generate for eye tracking. Additionally or alternatively, light source 110 and/or display device 116 may emit, produce, and/or generate different colors (e.g., red, blue, green, etc.) and/or wavelengths of electromagnetic radiation relative to one another. Examples of light source 110 and/or display device 116 include, without limitation, light-emitting diodes, laser devices, vertical-cavity surface-emitting laser (VCSEL) devices, coherent or collimated light-emitting devices, fiber optics, waveguide-driven lasers, combinations or variations of one or more of the same, and/or any other suitable light sources.

In some examples, light sensor 112 may include and/or represent any type or form of device capable of sensing and/or detecting light 120. In one example, light sensor 112 may include and/or represent a camera capable of imaging and/or mapping eye 122 based at least in part on light 120. Examples of light sensor 112 include, without limitation, cameras, charge coupled devices (CCDs), photodiode arrays, complementary metal-oxide-semiconductor (CMOS) based sensor devices, combinations or variations of one or more of the same, and/or any other suitable type of light sensor.

In some examples, eyewear device 100 may provide diverse and/or distinctive user experiences. In one example, eyewear device 100 may provide virtual-reality experiences (i.e., they may display computer-generated or pre-recorded content). In another example, eyewear device 100 may provide real-world experiences (i.e., they may display live imagery from the physical world). Additionally or alternatively, eyewear device 100 may provide any mixture and/or combination of live and virtual content. For example, virtual content may be projected onto the physical world (e.g., via optical or video see-through lenses), thereby resulting in AR and/or mixed-reality experiences.

In some examples, circuitry 106 may include and/or represent one or more electrical and/or electronic circuits capable of processing, applying, modifying, transforming, displaying, transmitting, receiving, and/or executing data and/or signals for eyewear device 100. In one example, circuitry 106 may launch, perform, and/or execute certain executable files, code snippets, and/or computer-readable instructions to facilitate and/or support artificial reality and/or eye tracking. In certain implementations, circuitry 106 may include and/or represent a collection of multiple processing units and/or electrical or electronic components that work and/or operate in conjunction with one another.

Examples of circuitry 106 include, without limitation, application-specific integrated circuits (ASICs), central processing units (CPUs), graphics processing units (GPUs), processing devices, microprocessors, microcontrollers, field-programmable gate arrays (FPGAs), systems on chips (SoCs), parallel accelerated processors, tensor cores, integrated circuits, chiplets, optical modules, receivers, transmitters, transceivers, optical modules, memory devices, transistors, antennas, resistors, capacitors, diodes, inductors, switches, registers, flipflops, digital logic, connections, traces, buses, semiconductor (e.g., silicon) devices and/or structures, storage devices, audio controllers, portions of one or more of the same, variations or combinations of one or more of the same, and/or any other suitable circuitry.

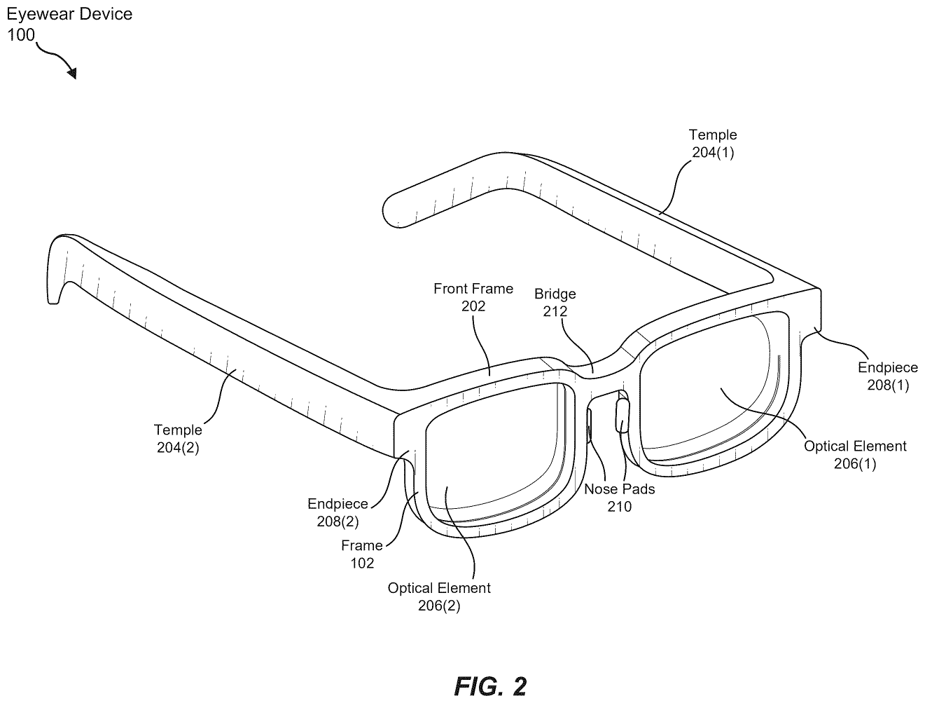

FIG. 2 illustrates an exemplary implementation of eyewear device 100 equipped with one or more eye-tracking components integrated into a display assembly. In some examples, eyewear device 100 may include and/or represent certain devices, components, and/or features that perform and/or provide functionalities that are similar and/or identical to those described above in connection with FIG. 1. As illustrated in FIG. 2, eyewear device 100 may include and/or represent frame 102 dimensioned to be worn by a user. In one example, frame 102 may include and/or represent a front frame 202, temples 204(1) and 204(2), optical elements 206(1) and 206(2), endpieces 208(1) and 208(2), nose pads 210, and/or a bridge 212. Additionally or alternatively, frame 102 may include, implement, and/or incorporate display assembly 104, eye-tracking device 108, and/or circuitry 106—at least some of which are not necessarily illustrated, visible, and/or labelled in FIG. 2.

In some examples, optical elements 206(1) and 206(2) may be inserted and/or installed in front frame 202. In other words, optical elements 206(1) and 206(2) may be coupled to, incorporated in, and/or held by eyewear frame 102. In one example, optical elements 206(1) and 206(2) may be configured and/or arranged to provide one or more virtual visual features for presentation to a user wearing eyewear device 100. These virtual visual features may be driven, influenced, and/or controlled by one or more wireless technologies supported by eyewear device 100.

In some examples, optical elements 206(1) and 206(2) may each include and/or represent optical stacks, lenses, and/or films. In one example, optical elements 206(1) and 206(2) may each include and/or represent various layers that facilitate and/or support the presentation of virtual features and/or elements that overlay real-world features and/or elements. Additionally or alternatively, optical elements 206(1) and 206(2) may each include and/or represent one or more screens, lenses, and/or fully or partially see-through components. Examples of optical elements 206(1) and 206(2) include, without limitation, electrochromic layers, dimming stacks, transparent conductive layers (such as indium tin oxide films), metal meshes, antennas, transparent resin layers, lenses, films, combinations or variations of one or more of the same, and/or any other suitable optical elements.

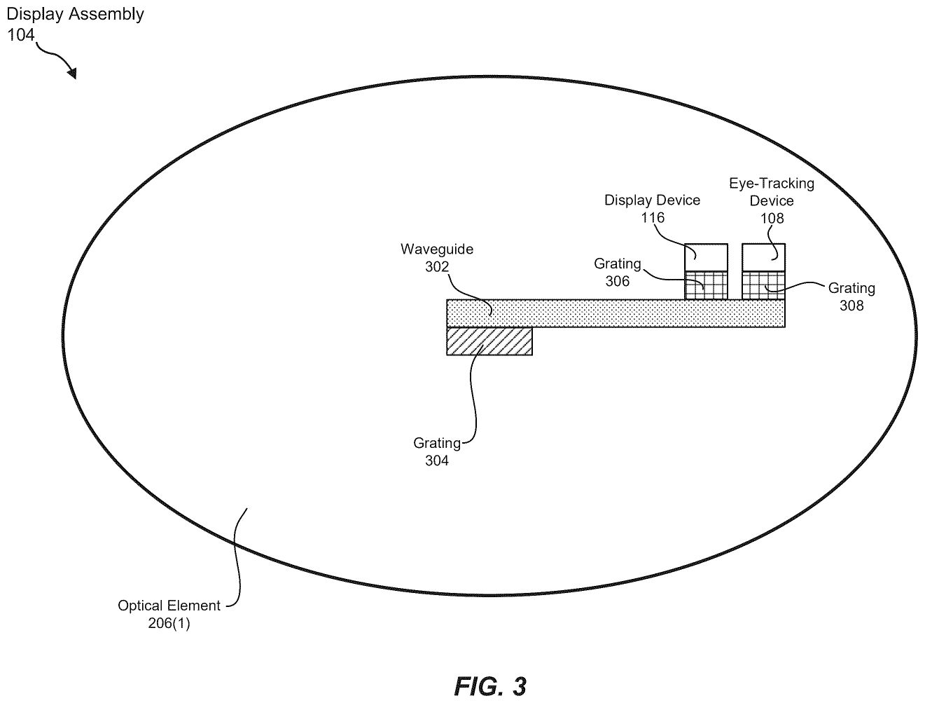

FIG. 3 illustrates an exemplary implementation of display assembly 104 with one or more integrated eye-tracking components. In some examples, display assembly 104 in FIG. 3 may include, involve, and/or represent certain devices, components, and/or features that perform and/or provide functionalities that are similar and/or identical to those described above in connection with either FIG. 1 or FIG. 2. As illustrated in FIG. 3, display assembly 104 may include and/or represent eye-tracking device 108, display device 116, optical element 206(1), a waveguide 302, a grating 304, a grating 306, and/or a grating 308.

In one example, waveguide 302 may be integrated into, coupled to, and/or disposed on optical element 206(1). In this example, waveguide 302 may direct and/or guide graphical imagery 118 generated by display device 116 and/or its constituent light components from display device 116 toward eye 122. For example, waveguide 302 may include and/or contain reflective materials that create an optical channel and/or path through which light 120 is directed and/or guided from one grating and/or coupling point to another.

Additionally or alternatively, waveguide 302 may direct and/or guide light 120 from light source 110 toward eye 122 and/or from eye 122 toward light sensor 112. In another example, light 120 may travel and/or traverse from light source 110 toward eye 122 outside of and/or external to waveguide 302, but waveguide 302 may direct and/or guide light 120 from eye 122 toward light sensor 112. For example, although not necessarily illustrated in this way in FIG. 3, light source 110 may be positioned and/or applied outside display assembly 104 and/or separate from light sensor 112 (e.g., along the perimeter of optical element 206(1) and/or on frame 102). In certain implementations, some components and/or features of display assembly 104 may be integrated into and/or coupled to optical element 206(1) and/or frame 102.

In certain examples, some or all of eye-tracking device 108 (e.g., light sensor 112) may be optically coupled to waveguide 302 via grating 308. In one example, display device 116 may be optically coupled to waveguide 302 via grating 306. Additionally or alternatively, waveguide 302 may be optically coupled to eye 122 via grating 304.

In some examples, one or more of gratings 304, 306, and 308 may constitute and/or represent optical coupling points through which light is transferred and/or passed from one device, component, and/or feature to another. In one example, waveguide 302 and/or display assembly 104 may include and/or implement an optical filter that selectively transmits light of certain wavelengths and selectively reflects light of other wavelengths. For example, display assembly 104 may include and/or implement an optical filter (e.g., a dichroic mirror, a beamsplitter, etc.) that transmits light 120 to light sensor 112 via grating 308 but prevents light emitted by display device 116 from reaching light sensor 112 via grating 308.

In some examples, although not necessarily illustrated in this way in FIG. 3, light sensor 112 may be optically coupled to waveguide 302 via grating 308. However, light source 110 may or may not be optically coupled to waveguide 302 via grating 308. For example, instead of being optically coupled to waveguide 302 via grating 308, light source 110 may be aimed directly at eye 122 outside of and/or external to waveguide 302. In this example, light source 110 may emit and/or direct light 120 onto eye 122, which then reflects light 120 into waveguide 302 via grating 304. Waveguide 302 may then direct and/or guide light 120 to light sensor 112 via grating 308.

In some examples, grating 308 may function and/or serve as an output for light 120 exiting waveguide 302 toward eye-tracking device 108. Additionally or alternatively, grating 308 may function and/or serve as an input for light 120 entering waveguide 302 from eye-tracking device 108 if light source 110 is positioned alongside and/or packaged with light sensor 112. In one example, grating 306 may function and/or serve as an input for light entering waveguide 302 from display device 116. In this example, grating 304 may function and/or serve as an input for light 120 entering waveguide 302 from eye 122. In certain implementations, grating 304 may also function and/or serve as an output for light emitted by display device 116 exiting waveguide 302 toward eye 122.

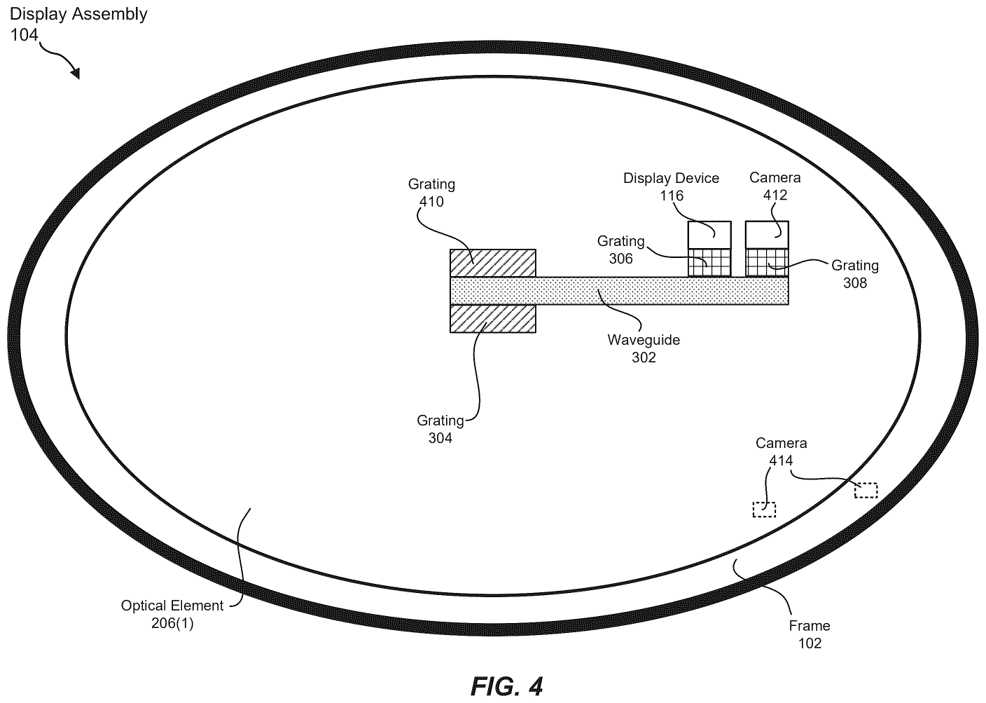

FIG. 4 illustrates an exemplary implementation of display assembly 104 with one or more integrated eye-tracking components. In some examples, display assembly 104 in FIG. 4 may include, involve, and/or represent certain devices, components, and/or features that perform and/or provide functionalities that are similar and/or identical to those described above in connection with any of FIGS. 1-3. As illustrated in FIG. 4, display assembly 104 may include and/or represent display device 116, optical element 206(1), waveguide 302, grating 304, grating 306, grating 308, a grating 410, a camera 412, and/or a camera 414. In one example, display assembly 104 may be integrated into and/or coupled to frame 102.

In some examples, camera 412 may be optically coupled to waveguide 302 via grating 308. In one example, display device 116 may be optically coupled to waveguide 302 via grating 306. Additionally or alternatively, waveguide 302 may be optically coupled to eye 122 via grating 304 and/or grating 410. In certain implementations, camera 414 may be directly toward eye 122 without the use of any intermediary waveguide (e.g., waveguide 302).

In some examples, waveguide 302 and/or display assembly 104 may include and/or implement an optical filter that selectively transmits light of certain wavelengths through grating 304 and/or grating 504 or that selectively transmits light of other wavelengths through grating 410. For example, display assembly 104 may include and/or implement an optical filter (e.g., a dichroic mirror, a beamsplitter, etc.) that selectively transmits light 120 from eye 122 to camera 412 via grating 304, waveguide 302, and/or grating 308. Additionally or alternatively, display assembly 104 may include and/or implement an optical filter (e.g., a dichroic mirror, a beamsplitter, etc.) that selectively transmits light emitted by display device 116 to eye 122 via grating 306, waveguide 302, and/or grating 410.

In some examples, grating 304 may function and/or serve as an input for light 120 entering waveguide 302 from eye 122. Additionally or alternatively, grating 410 may function and/or serve as an output for light emitted by display device 116 exiting waveguide 302 toward eye 122.

In some examples, camera 412 may capture images of eye 122 based at least in part on light 120 traversing through waveguide 302. In one example, camera 414 may capture images of eye 122 directly without relying on any intermediary waveguides. As a specific example, camera 412 may image and/or map the user's retina via light 120 directed by waveguide 302, and camera 414 may image and/or map the user's sclera and/or pupil directly from eye 122. In this example, circuitry 106 may implement and/or perform stereo imaging of eye 122 via camera 412 and camera 414. Accordingly, circuitry 106 may use images captured by cameras 412 and 414 to achieve and/or implement stereo imaging of eye 122.

In some examples, camera 414 may be positioned and/or applied outside display assembly 104 and/or separate from camera 414 (e.g., along the perimeter of optical element 206(1) and/or on frame 102). In one example, camera 414 may be integrated into and/or coupled to frame 102 and/or to the perimeter of optical element 206(1).

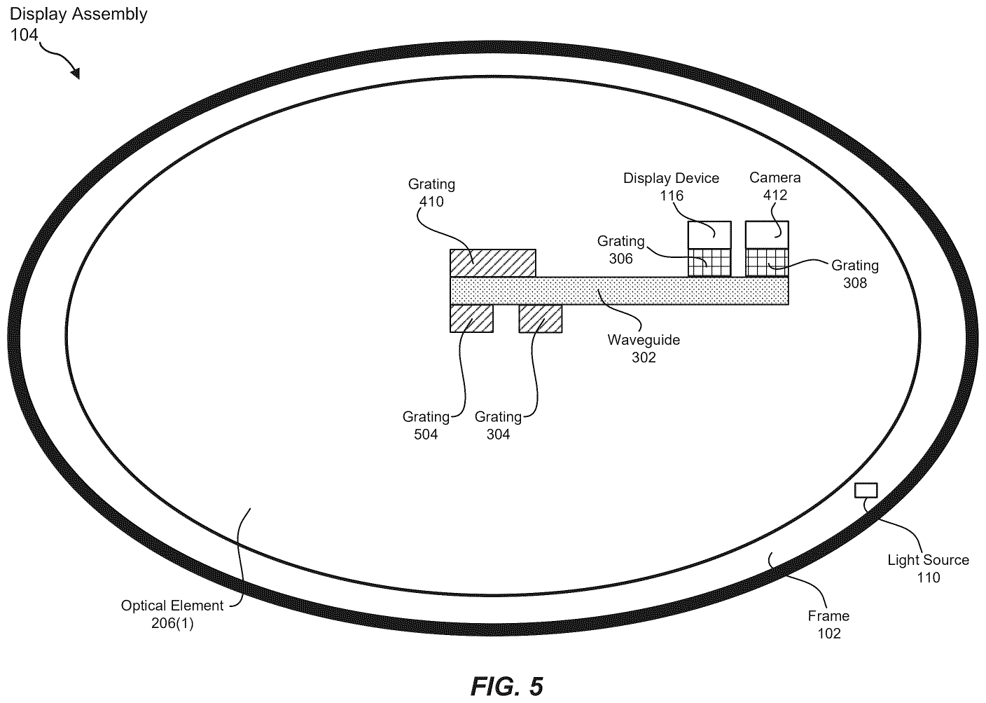

FIG. 5 illustrates an exemplary implementation of display assembly 104 with one or more integrated eye-tracking components. In some examples, display assembly 104 in FIG. 5 may include, involve, and/or represent certain devices, components, and/or features that perform and/or provide functionalities that are similar and/or identical to those described above in connection with any of FIGS. 1-4. As illustrated in FIG. 5, display assembly 104 may include and/or represent light source 110, display device 116, optical element 206(1), waveguide 302, grating 304, grating 306, grating 308, grating 410, a grating 504, and/or camera 412. In one example, display assembly 104 may be integrated into and/or coupled to frame 102.

In some examples, camera 412 may be optically coupled to waveguide 302 via grating 308. In one example, display device 116 may be optically coupled to waveguide 302 via grating 306. Additionally or alternatively, waveguide 302 may be optically coupled to eye 122 via grating 304, grating 410, and/or grating 504.

In some examples, waveguide 302 and/or display assembly 104 may include and/or implement an optical filter that selectively transmits light of certain wavelengths through grating 304 and/or grating 504 or that selectively transmits light of other wavelengths through grating 410. For example, display assembly 104 may include and/or implement an optical filter (e.g., a dichroic mirror, a beamsplitter, etc.) that selectively transmits light 120 from eye 122 to camera 412 via grating 410, waveguide 302, and/or grating 308. Additionally or alternatively, display assembly 104 may include and/or implement an optical filter (e.g., a dichroic mirror, a beamsplitter, etc.) that selectively transmits light emitted by display device 116 to eye 122 via grating 306, waveguide 302, and/or grating 304.

In some examples, waveguide 302 and/or display assembly 104 may include and/or implement an optical filter that selectively transmits light of certain wavelengths through grating 304 and/or selectively transmits light of other wavelengths through grating 410. For example, display assembly 104 may include and/or implement an optical filter (e.g., a dichroic mirror, a beamsplitter, etc.) that selectively transmits light 120 from eye 122 to camera 412 via grating 304, grating 504, waveguide 302, and/or grating 308. Additionally or alternatively, display assembly 104 may include and/or implement an optical filter (e.g., a dichroic mirror, a beamsplitter, etc.) that selectively transmits light emitted by display device 116 to eye 122 via grating 306, waveguide 302, and/or grating 410.

In some examples, gratings 304 and 504 may function and/or serve dual inputs for light 120 entering waveguide 302 from eye 122. In one example, these dual inputs may effectively enable camera 412 to image eye 122 as though camera 412 were two virtual cameras. Additionally or alternatively, grating 410 may function and/or serve as an output for light emitted by display device 116 exiting waveguide 302 toward eye 122.

In some examples, camera 412 may capture images of eye 122 based at least in part on light 120 captured via gratings 304 and 504. In one example, circuitry 106 may implement and/or perform stereo imaging of eye 122 based at least in part on images of eye 122 captured by camera 412 via gratings 304 and 504. Accordingly, circuitry 106 may use images captured by camera 412 via gratings 304 and 504 to achieve and/or implement stereo imaging of eye 122.

In some examples, display assembly 104 and/or display device 116 may include and/or represent a set of pixels positioned in a way that causes light emitted by display device 116 to project and/or form graphical imagery 118 for viewing by the user. In one example, the set of pixels may be positioned and/or secured to facilitate projecting the light emitted by display device 116 and/or graphical imagery 118 to eye 122 at a certain angle. In this example, eye-tracking device 108 may also be positioned and/or secured proximate to one or more of those pixels such that light 120 is received, detected, and/or captured at that same angle. In certain implementations, the set of pixels and eye-tracking device 108 may be positioned and/or secured along a single optical plane conjugate to eye 122.

In some examples, circuitry 106 may predict changes in the user's gaze based at least in part on the past gaze changes and the graphical imagery presented to the user before and/or during those gaze changes. In one example, circuitry 106 may be trained, programmed, and/or configured to predict future changes in the user's gaze based at least in part on the graphical imagery projected to eye 122 at a certain moment in time and/or the movements made by eye 122 around that moment in time. For example, circuitry 106 may predict and/or anticipate a likely change in the user's gaze based at least in part on the graphical imagery projected to eye 122 at that time and/or any past gaze changes performed by eye 122 when similar or identical graphical imagery was previously projected to eye 122.

In some examples, eyewear device 100 may be communicatively coupled to a computing device directly and/or through a network. In one example, eyewear device 100 may leverage and/or harness the computing power of the computing device for one reason or another (e.g., performing certain calculations, generating graphical imagery, coordinating AR/VR environments across multiple HMDs, etc.). Additionally or alternatively, eyewear device 100 may direct and/or cause the computing device to perform one or more actions (e.g., present certain graphical imagery to another user, performing calculations for use on the computing device or eyewear device 100, coordinating AR/VR environments across multiple HMDs, etc.)

In some examples, the various apparatuses, devices, and systems described in connection with FIGS. 1-5 may include and/or represent one or more additional circuits, components, and/or features that are not necessarily illustrated and/or labeled in FIGS. 1-5. For example, the apparatuses, devices, and systems illustrated in FIGS. 1-5 may also include and/or represent additional analog and/or digital circuitry, onboard logic, transistors, radio-frequency (RF) transmitters, RF receivers, RF transceivers, antennas, resistors, capacitors, diodes, inductors, switches, registers, flipflops, digital logic, connections, traces, buses, semiconductor (e.g., silicon) devices and/or structures, processing devices, storage devices, circuit boards, sensors, packages, substrates, housings, combinations or variations of one or more of the same, and/or any other suitable components. In certain implementations, one or more of these additional circuits, components, and/or features may be inserted and/or applied between any of the existing circuits, components, and/or features illustrated in FIGS. 1-5 consistent with the aims and/or objectives described herein. Accordingly, the couplings and/or connections described with reference to FIGS. 1-5 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components. In some examples, one or more components and/or features illustrated in FIGS. 1-5 may be excluded and/or omitted from the various apparatuses, devices, and/or systems described in connection with FIGS. 1-5.

FIG. 6 is a flow diagram of an exemplary method 600 for integrating eye-tracking components within display assemblies. In one example, the steps shown in FIG. 6 may be achieved and/or accomplished by a computing equipment manufacturer or subcontractor that creates and/or assembles smart eyewear devices. Additionally or alternatively, the steps shown in FIG. 6 may incorporate and/or involve certain sub-steps and/or variations consistent with the descriptions provided above in connection with FIGS. 1-5.

As illustrated in FIG. 6, method 600 may include the step of configuring a display assembly to generate graphical imagery for viewing by a user (610). Step 610 may be performed in a variety of ways, including any of those described above in connection with FIGS. 1-5. For example, a computing equipment manufacturer or subcontractor may configure and/or arrange a display assembly to generate graphical imagery for viewing by a user.

Method 600 may also include the step of at least partially integrating an eye-tracking device into the display assembly (620). Step 620 may be performed in a variety of ways, including any of those described above in connection with FIGS. 1-5. For example, the computing equipment manufacturer or subcontractor may at least partially integrate and/or incorporate an eye-tracking device into the display assembly.

Method 600 may further include the step of communicatively coupling circuitry to the eye-tracking device (630). Step 630 may be performed in a variety of ways, including any of those described above in connection with FIGS. 1-5. For example, the computing equipment manufacturer or subcontractor may communicatively couple circuitry to the eye-tracking device.

Method 600 may further include the step of configuring the circuitry to track an eye of the user based at least in part on light detected by the eye-tracking device (640). Step 640 may be performed in a variety of ways, including any of those described above in connection with FIGS. 1-6. For example, the circuitry incorporated in the AR/VR HMD may modify the audio signal from the at least one additional signal to compensate for an imbalance between a volume level of the voice of the user and a volume level of the at least one additional audio signal.

### EXAMPLE EMBODIMENTS

Example 1: An eyewear device comprising (1) a display assembly configured to generate graphical imagery for viewing by a user, (2) an eye-tracking device at least partially integrated into the display assembly, and (3) circuitry communicatively coupled to the eye-tracking device and configured to track an eye of the user based at least in part on light detected by the eye-tracking device.

Example 2: The eyewear device of Example 1, further comprising a waveguide incorporated in the display assembly and configured to (1) direct the graphical imagery toward the eye of the user and (2) direct the light toward the eye-tracking device.

Example 3: The eyewear device of either Example 1 or Example 2, further comprising a display device configured to emit additional light used to form the graphical imagery, wherein the waveguide directs the light toward the eye-tracking device and directs the additional light toward the eye of the user.

Example 4: The eyewear device of any of Examples 1-3, wherein the eye-tracking device is optically coupled to the waveguide via a first grating and the display device is optically coupled to the waveguide via a second grating.

Example 5: The eyewear device of any of Examples 1-4, wherein the waveguide is optically coupled to the eye of the user via a third grating such that the waveguide directs the light from the third grating to the first grating and directs the additional light from the second grating to the first grating.

Example 6: The eyewear device of any of Examples 1-5, wherein (1) the first grating functions as an output for the light exiting the waveguide toward the eye-tracking device, (2) the second grating functions as an input for the additional light entering the waveguide from the display device, and (3) the third grating functions as an input for the light entering the waveguide from the eye of the user and as an output for the additional light exiting the waveguide toward the eye of the user.

Example 7: The eyewear device of any of Examples 1-6, wherein the waveguide is optically coupled to the eye of the user via (1) a third grating through which the light enters from the eye of the user and (2) a fourth grating through which the additional light exits toward the eye of the user.

Example 8: The eyewear device of any of Examples 1-7, wherein the waveguide is optically coupled to the eye of the user via (1) a third grating through which a first portion of the light enters from the eye-of the user and (2) a fourth grating through which a first portion of the light enters from the eye-of the user.

Example 9: The eyewear device of any of Examples 1-8, wherein the eye-tracking device comprises (1) a first camera configured to image a retina of the user via the light directed by the waveguide and (2) a second camera configured to image a sclera of the eye or a pupil of the eye.

Example 10: The eyewear device of any of Examples 1-9, wherein the circuitry is further configured to perform stereo imaging of the eye of the user via the first camera and the second camera.

Example 11: The eyewear device of any of Examples 1-10, further comprising a frame dimensioned to be worn by the user, wherein (1) the display assembly comprises a lens that is coupled to the frame, (2) the first camera is optically coupled to the waveguide, and (3) the second camera is positioned along a perimeter of the lens or on the frame.

Example 12: The eyewear device of any of Examples 1-11, wherein the display assembly comprises a set of pixels that are positioned to project the graphical imagery to the eye of the user at a certain angle, wherein the eye-tracking device is positioned proximate to at least one of the pixels such that the light is detected at the certain angle.

Example 13: The eyewear device of any of Examples 1-12, wherein the set of pixels and the eye-tracking device are positioned along a single optical plane conjugate to the eye of the user.

Example 14: The eyewear device of any of Examples 1-13, wherein the eye-tracking device comprises a light source that emits the light and a light sensor that detects the light.

Example 15: The eyewear device of any of Examples 1-14, wherein the circuitry is further configured to predict a change in a gaze of the user based at least in part on (1) the graphical imagery projected to the eye of the user at a certain moment in time and (2) one or more movements made by the eye of the user around the certain moment in time.

Example 16: The eyewear device of any of Examples 1-15, wherein the display assembly comprises a scanning display that rasterizes additional light into the graphical imagery for viewing by a user.

Example 17: An artificial-reality system comprising (1) an eyewear device comprising (A) a display assembly configured to generate graphical imagery for viewing by a user, (B) an eye-tracking device at least partially integrated into the display assembly, and (C) circuitry communicatively coupled to the eye-tracking device and configured to track the eye of the user based at least in part on light detected by the eye-tracking device, and (2) a computing device communicatively coupled to the eyewear device.

Example 18: The artificial-reality system of Example 17, further comprising a waveguide incorporated in the display assembly and configured to (1) direct the graphical imagery toward the eye of the user and (2) direct the light toward the eye-tracking device.

Example 19: The artificial-reality system of either Example 17 or Example 18, further comprising a display device configured to emit additional light used to form the graphical imagery, wherein the waveguide directs the light toward the eye-tracking device and directs the additional light toward the eye of the user.

Example 20: A method comprising (1) configuring a display assembly to generate graphical imagery for viewing by a user, (2) at least partially integrating an eye-tracking device into the display assembly, (3) communicatively coupling circuitry to the eye-tracking device, and (4) configuring the circuitry to track an eye of the user based at least in part on light detected by the eye-tracking device.

Embodiments of the present disclosure may include or be implemented in conjunction with various types of artificial-reality systems. Artificial reality is a form of reality that has been adjusted in some manner before presentation to a user, which may include, for example, a VR, an AR, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a 3D effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

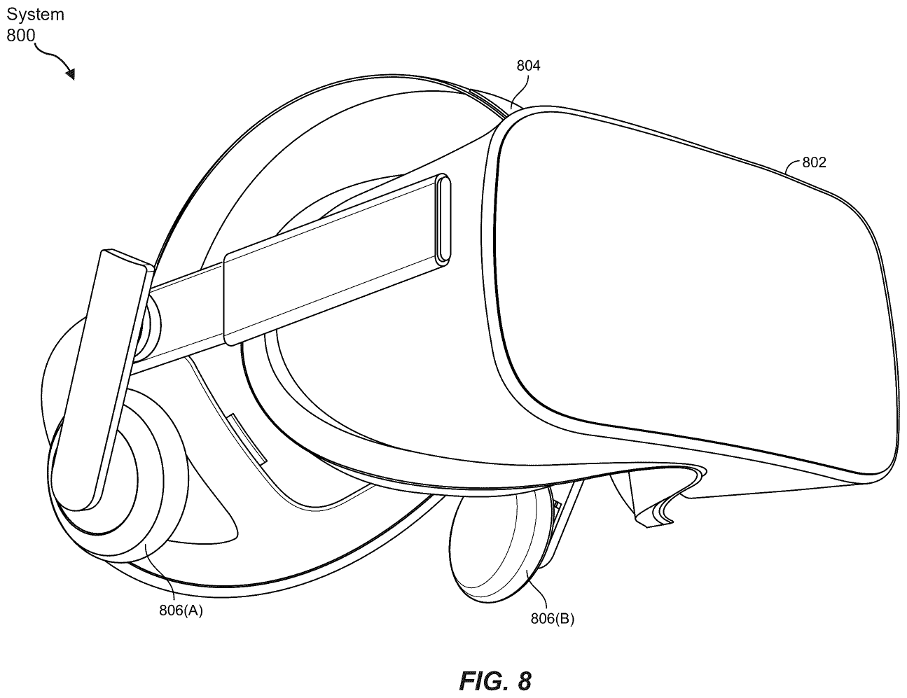

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 700 in FIG. 7) or that visually immerses a user in an artificial reality (such as, e.g., virtual-reality system 800 in FIG. 8). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 7, augmented-reality system 700 may include an eyewear device 702 with a frame 710 configured to hold a left display device 715(A) and a right display device 715(B) in front of a user's eyes. Display devices 715(A) and 715(B) may act together or independently to present an image or series of images to a user. While augmented-reality system 700 includes two displays, embodiments of this disclosure may be implemented in augmented-reality systems with a single NED or more than two NEDs.

In some embodiments, augmented-reality system 700 may include one or more sensors, such as sensor 740. Sensor 740 may generate measurement signals in response to motion of augmented-reality system 700 and may be located on substantially any portion of frame 710. Sensor 740 may represent one or more of a variety of different sensing mechanisms, such as a position sensor, an inertial measurement unit (IMU), a depth camera assembly, a structured light emitter and/or detector, or any combination thereof. In some embodiments, augmented-reality system 700 may or may not include sensor 740 or may include more than one sensor. In embodiments in which sensor 740 includes an IMU, the IMU may generate calibration data based on measurement signals from sensor 740. Examples of sensor 740 may include, without limitation, accelerometers, gyroscopes, magnetometers, other suitable types of sensors that detect motion, sensors used for error correction of the IMU, or some combination thereof.

In some examples, augmented-reality system 700 may also include a microphone array with a plurality of acoustic transducers 720(A)-720(J), referred to collectively as acoustic transducers 720. Acoustic transducers 720 may represent transducers that detect air pressure variations induced by sound waves. Each acoustic transducer 720 may be configured to detect sound and convert the detected sound into an electronic format (e.g., an analog or digital format). The microphone array in FIG. 7 may include, for example, ten acoustic transducers: 720(A) and 720(B), which may be designed to be placed inside a corresponding ear of the user, acoustic transducers 720(C), 720(D), 720(E), 720(F), 720(G), and 720(H), which may be positioned at various locations on frame 710, and/or acoustic transducers 720(I) and 720(J), which may be positioned on a corresponding neckband 705.

In some embodiments, one or more of acoustic transducers 720(A)-(J) may be used as output transducers (e.g., speakers). For example, acoustic transducers 720(A) and/or 720(B) may be earbuds or any other suitable type of headphone or speaker.

The configuration of acoustic transducers 720 of the microphone array may vary. While augmented-reality system 700 is shown in FIG. 7 as having ten acoustic transducers 720, the number of acoustic transducers 720 may be greater or less than ten. In some embodiments, using higher numbers of acoustic transducers 720 may increase the amount of audio information collected and/or the sensitivity and accuracy of the audio information. In contrast, using a lower number of acoustic transducers 720 may decrease the computing power required by an associated controller 750 to process the collected audio information. In addition, the position of each acoustic transducer 720 of the microphone array may vary. For example, the position of an acoustic transducer 720 may include a defined position on the user, a defined coordinate on frame 710, an orientation associated with each acoustic transducer 720, or some combination thereof.

Acoustic transducers 720(A) and 720(B) may be positioned on different parts of the user's ear, such as behind the pinna, behind the tragus, and/or within the auricle or fossa. Or, there may be additional acoustic transducers 720 on or surrounding the ear in addition to acoustic transducers 720 inside the ear canal. Having an acoustic transducer 720 positioned next to an ear canal of a user may enable the microphone array to collect information on how sounds arrive at the ear canal. By positioning at least two of acoustic transducers 720 on either side of a user's head (e.g., as binaural microphones), AR system 700 may simulate binaural hearing and capture a 3D stereo sound field around about a user's head. In some embodiments, acoustic transducers 720(A) and 720(B) may be connected to augmented-reality system 700 via a wired connection 730, and in other embodiments acoustic transducers 720(A) and 720(B) may be connected to augmented-reality system 700 via a wireless connection (e.g., a BLUETOOTH connection). In still other embodiments, acoustic transducers 720(A) and 720(B) may not be used at all in conjunction with augmented-reality system 700.

Acoustic transducers 720 on frame 710 may be positioned in a variety of different ways, including along the length of the temples, across the bridge, above or below display devices 715(A) and 715(B), or some combination thereof. Acoustic transducers 720 may also be oriented such that the microphone array is able to detect sounds in a wide range of directions surrounding the user wearing the augmented-reality system 700. In some embodiments, an optimization process may be performed during manufacturing of augmented-reality system 700 to determine relative positioning of each acoustic transducer 720 in the microphone array.

In some examples, augmented-reality system 700 may include or be connected to an external device (e.g., a paired device), such as neckband 705. Neckband 705 generally represents any type or form of paired device. Thus, the following discussion of neckband 705 may also apply to various other paired devices, such as charging cases, smart watches, smart phones, wrist bands, other wearable devices, hand-held controllers, tablet computers, laptop computers, other external compute devices, etc.

As shown, neckband 705 may be coupled to eyewear device 702 via one or more connectors. The connectors may be wired or wireless and may include electrical and/or non-electrical (e.g., structural) components. In some cases, eyewear device 702 and neckband 705 may operate independently without any wired or wireless connection between them. While FIG. 7 illustrates the components of eyewear device 702 and neckband 705 in example locations on eyewear device 702 and neckband 705, the components may be located elsewhere and/or distributed differently on eyewear device 702 and/or neckband 705. In some embodiments, the components of eyewear device 702 and neckband 705 may be located on one or more additional peripheral devices paired with eyewear device 702, neckband 705, or some combination thereof.

Pairing external devices, such as neckband 705, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 700 may be provided by a paired device or shared between a paired device and an eyewear device, thus reducing the weight, heat profile, and form factor of the eyewear device overall while still retaining desired functionality. For example, neckband 705 may allow components that would otherwise be included on an eyewear device to be included in neckband 705 since users may tolerate a heavier weight load on their shoulders than they would tolerate on their heads. Neckband 705 may also have a larger surface area over which to diffuse and disperse heat to the ambient environment. Thus, neckband 705 may allow for greater battery and computation capacity than might otherwise have been possible on a stand-alone eyewear device. Since weight carried in neckband 705 may be less invasive to a user than weight carried in eyewear device 702, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 705 may be communicatively coupled with eyewear device 702 and/or to other devices. These other devices may provide certain functions (e.g., tracking, localizing, depth mapping, processing, storage, etc.) to augmented-reality system 700. In the embodiment of FIG. 7, neckband 705 may include two acoustic transducers (e.g., 720(I) and 720(J)) that are part of the microphone array (or potentially form their own microphone subarray). Neckband 705 may also include a controller 725 and a power source 735.

Acoustic transducers 720(I) and 720(J) of neckband 705 may be configured to detect sound and convert the detected sound into an electronic format (analog or digital). In the embodiment of FIG. 7, acoustic transducers 720(I) and 720(J) may be positioned on neckband 705, thereby increasing the distance between the neckband acoustic transducers 720(I) and 720(J) and other acoustic transducers 720 positioned on eyewear device 702. In some cases, increasing the distance between acoustic transducers 720 of the microphone array may improve the accuracy of beamforming performed via the microphone array. For example, if a sound is detected by acoustic transducers 720(C) and 720(D) and the distance between acoustic transducers 720(C) and 720(D) is greater than, e.g., the distance between acoustic transducers 720(D) and 720(E), the determined source location of the detected sound may be more accurate than if the sound had been detected by acoustic transducers 720(D) and 720(E).

Controller 725 of neckband 705 may process information generated by the sensors on neckband 705 and/or augmented-reality system 700. For example, controller 725 may process information from the microphone array that describes sounds detected by the microphone array. For each detected sound, controller 725 may perform a direction-of-arrival (DOA) estimation to estimate a direction from which the detected sound arrived at the microphone array. As the microphone array detects sounds, controller 725 may populate an audio data set with the information. In embodiments in which augmented-reality system 700 includes an inertial measurement unit, controller 725 may compute all inertial and spatial calculations from the IMU located on eyewear device 702. A connector may convey information between augmented-reality system 700 and neckband 705 and between augmented-reality system 700 and controller 725. The information may be in the form of optical data, electrical data, wireless data, or any other transmittable data form. Moving the processing of information generated by augmented-reality system 700 to neckband 705 may reduce weight and heat in eyewear device 702, making it more comfortable to the user.

Power source 735 in neckband 705 may provide power to eyewear device 702 and/or to neckband 705. Power source 735 may include, without limitation, lithium-ion batteries, lithium-polymer batteries, primary lithium batteries, alkaline batteries, or any other form of power storage. In some cases, power source 735 may be a wired power source. Including power source 735 on neckband 705 instead of on eyewear device 702 may help better distribute the weight and heat generated by power source 735.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 800 in FIG. 8, that mostly or completely covers a user's field of view. Virtual-reality system 800 may include a front rigid body 802 and a band 804 shaped to fit around a user's head. Virtual-reality system 800 may also include output audio transducers 806(A) and 806(B). Furthermore, while not shown in FIG. 8, front rigid body 802 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 700 and/or virtual-reality system 800 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 700 and/or virtual-reality system 800 may include microLED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 700 and/or virtual-reality system 800 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

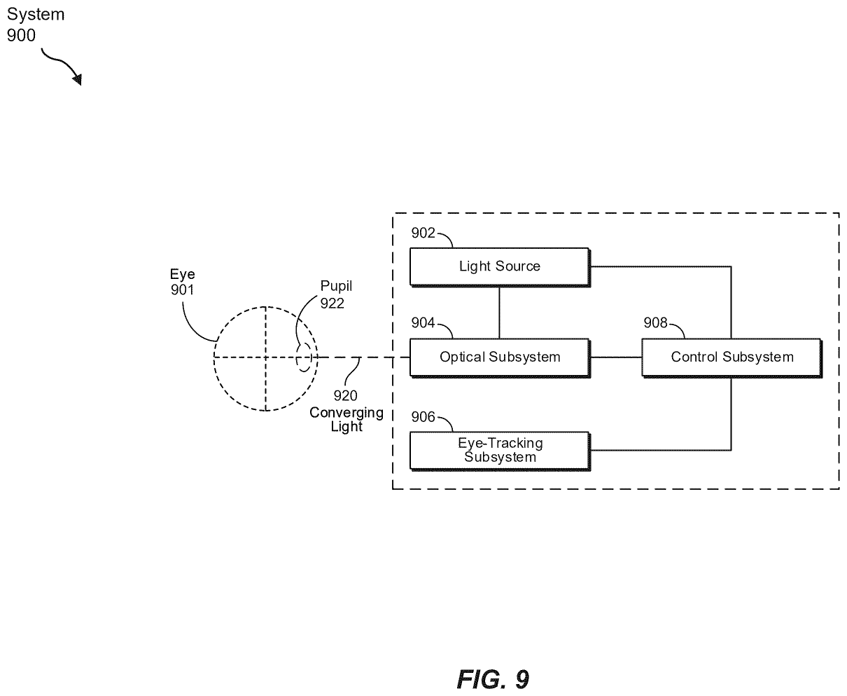

FIG. 9 is an illustration of an exemplary system 900 that incorporates an eye-tracking subsystem capable of tracking a user's eye(s). As depicted in FIG. 9, system 900 may include a light source 902, an optical subsystem 904, an eye-tracking subsystem 906, and/or a control subsystem 908. In some examples, light source 902 may generate light for an image (e.g., to be presented to an eye 901 of the viewer). Light source 902 may represent any of a variety of suitable devices. For example, light source 902 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 904 may receive the light generated by light source 902 and generate, based on the received light, converging light 920 that includes the image. In some examples, optical subsystem 904 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 920. Further, various mechanical couplings may serve to maintain the relative spacing and/or the orientation of the optical components in any suitable combination.

In one embodiment, eye-tracking subsystem 906 may generate tracking information indicating a gaze angle of an eye 901 of the viewer. In this embodiment, control subsystem 908 may control aspects of optical subsystem 904 (e.g., the angle of incidence of converging light 920) based at least in part on this tracking information. Additionally, in some examples, control subsystem 908 may store and utilize historical tracking information (e.g., a history of the tracking information over a given duration, such as the previous second or fraction thereof) to anticipate the gaze angle of eye 901 (e.g., an angle between the visual axis and the anatomical axis of eye 901). In some embodiments, eye-tracking subsystem 906 may detect radiation emanating from some portion of eye 901 (e.g., the cornea, the iris, the pupil, or the like) to determine the current gaze angle of eye 901. In other examples, eye-tracking subsystem 906 may employ a wavefront sensor to track the current location of the pupil.

Any number of techniques can be used to track eye 901. Some techniques may involve illuminating eye 901 with infrared light and measuring reflections with at least one optical sensor that is tuned to be sensitive to the infrared light. Information about how the infrared light is reflected from eye 901 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 906 may be digitized (i.e., converted to an electronic signal). Further, the sensor may transmit a digital representation of this electronic signal to one or more processors (for example, processors associated with a device including eye-tracking subsystem 906). Eye-tracking subsystem 906 may include any of a variety of sensors in a variety of different configurations. For example, eye-tracking subsystem 906 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 906 to track the movement of eye 901. In another example, these processors may track the movements of eye 901 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 906 may be programmed to use an output of the sensor(s) to track movement of eye 901. In some embodiments, eye-tracking subsystem 906 may analyze the digital representation generated by the sensors to extract eye rotation information from changes in reflections. In one embodiment, eye-tracking subsystem 906 may use corneal reflections or glints (also known as Purkinje images) and/or the center of the eye's pupil 922 as features to track over time.

In some embodiments, eye-tracking subsystem 906 may use the center of the eye's pupil 922 and infrared or near-infrared, non-collimated light to create corneal reflections. In these embodiments, eye-tracking subsystem 906 may use the vector between the center of the eye's pupil 922 and the corneal reflections to compute the gaze direction of eye 901. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 906 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 901 may act as a retroreflector as the light reflects off the retina, thereby creating a bright pupil effect similar to a red-eye effect in photography. If the illumination source is offset from the optical path, then the eye's pupil 922 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 908 may control light source 902 and/or optical subsystem 904 to reduce optical aberrations (e.g., chromatic aberrations and/or monochromatic aberrations) of the image that may be caused by or influenced by eye 901. In some examples, as mentioned above, control subsystem 908 may use the tracking information from eye-tracking subsystem 906 to perform such control. For example, in controlling light source 902, control subsystem 908 may alter the light generated by light source 902 (e.g., by way of image rendering) to modify (e.g., pre-distort) the image so that the aberration of the image caused by eye 901 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial-reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

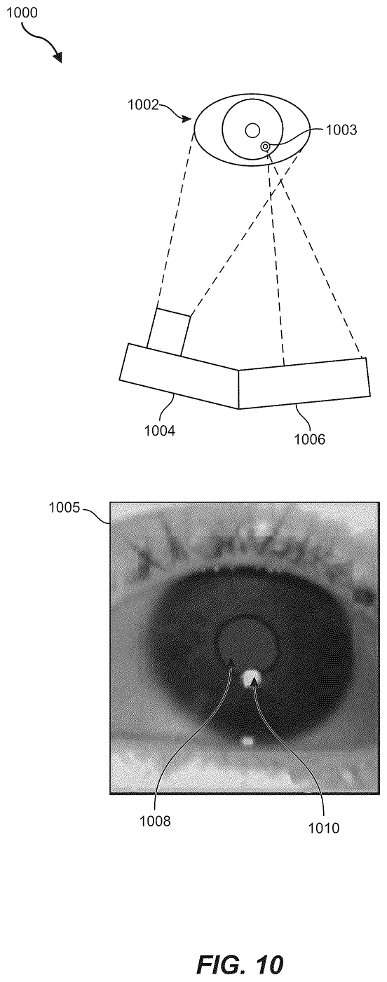

FIG. 10 is a more detailed illustration of various aspects of the eye-tracking subsystem illustrated in FIG. 9. As shown in this figure, an eye-tracking subsystem 1000 may include at least one source 1004 and at least one sensor 1006. Source 1004 generally represents any type or form of element capable of emitting radiation. In one example, source 1004 may generate visible, infrared, and/or near-infrared radiation. In some examples, source 1004 may radiate non-collimated infrared and/or near-infrared portions of the electromagnetic spectrum towards an eye 1002 of a user. Source 1004 may utilize a variety of sampling rates and speeds. For example, the disclosed systems may use sources with higher sampling rates in order to capture fixational eye movements of a user's eye 1002 and/or to correctly measure saccade dynamics of the user's eye 1002. As noted above, any type or form of eye-tracking technique may be used to track the user's eye 1002, including optical-based eye-tracking techniques, ultrasound-based eye-tracking techniques, etc.

Sensor 1006 generally represents any type or form of element capable of detecting radiation, such as radiation reflected off the user's eye 1002. Examples of sensor 1006 include, without limitation, a charge coupled device (CCD), a photodiode array, a complementary metal-oxide-semiconductor (CMOS) based sensor device, and/or the like. In one example, sensor 1006 may represent a sensor having predetermined parameters, including, but not limited to, a dynamic resolution range, linearity, and/or other characteristic selected and/or designed specifically for eye tracking.

As detailed above, eye-tracking subsystem 1000 may generate one or more glints. As detailed above, a glint 1003 may represent reflections of radiation (e.g., infrared radiation from an infrared source, such as source 1004) from the structure of the user's eye. In various embodiments, glint 1003 and/or the user's pupil may be tracked using an eye-tracking algorithm executed by a processor (either within or external to an artificial-reality device). For example, an artificial-reality device may include a processor and/or a memory device in order to perform eye tracking locally and/or a transceiver to send and receive the data necessary to perform eye tracking on an external device (e.g., a mobile phone, cloud server, or other computing device).

FIG. 10 shows an example image 1005 captured by an eye-tracking subsystem, such as eye-tracking subsystem 1000. In this example, image 1005 may include both the user's pupil 1008 and a glint 1010 near the same. In some examples, pupil 1008 and/or glint 1010 may be identified using an artificial-intelligence-based algorithm, such as a computer-vision-based algorithm. In one embodiment, image 1005 may represent a single frame in a series of frames that may be analyzed continuously in order to track the eye 1002 of the user. Further, pupil 1008 and/or glint 1010 may be tracked over a period of time to determine a user's gaze.

In one example, eye-tracking subsystem 1000 may be configured to identify and measure the inter-pupillary distance (IPD) of a user. In some embodiments, eye-tracking subsystem 1000 may measure and/or calculate the IPD of the user while the user is wearing the artificial-reality system. In these embodiments, eye-tracking subsystem 1000 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial-reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial-reality systems described herein in a variety of ways. For example, one or more of the various components of system 900 and/or eye-tracking subsystem 1000 may be incorporated into augmented-reality system 700 in FIG. 7 and/or virtual-reality system 800 in FIG. 8 to enable these systems to perform various eye-tracking tasks (including one or more of the eye-tracking operations described herein).

The process parameters and sequence of the steps described and/or illustrated herein are given by way of example only and may be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An eyewear device comprising:
a display assembly configured to generate graphical imagery for viewing by a user;
an eye-tracking device at least partially integrated into the display assembly; and
circuitry communicatively coupled to the eye-tracking device and configured to track an eye of the user based at least in part on light detected by the eye-tracking device.

2. The eyewear device of claim 1, further comprising a waveguide incorporated in the display assembly and configured to:
direct the graphical imagery toward the eye of the user; and
direct the light toward the eye-tracking device.

3. The eyewear device of claim 2, further comprising a display device configured to emit additional light used to form the graphical imagery, wherein the waveguide directs the light toward the eye-tracking device and directs the additional light toward the eye of the user.

4. The eyewear device of claim 3, wherein the eye-tracking device is optically coupled to the waveguide via a first grating and the display device is optically coupled to the waveguide via a second grating.

5. The eyewear device of claim 4, wherein the waveguide is optically coupled to the eye of the user via a third grating such that the waveguide directs the light from the third grating to the first grating and directs the additional light from the second grating to the first grating.

6. The eyewear device of claim 5, wherein:
the first grating functions as an output for the light exiting the waveguide toward the eye-tracking device;
the second grating functions as an input for the additional light entering the waveguide from the display device; and
the third grating functions as an input for the light entering the waveguide from the eye of the user and as an output for the additional light exiting the waveguide toward the eye of the user.

7. The eyewear device of claim 4, wherein the waveguide is optically coupled to the eye of the user via:
a third grating through which the light enters from the eye of the user; and
a fourth grating through which the additional light exits toward the eye of the user.

8. The eyewear device of claim 4, wherein the waveguide is optically coupled to the eye of the user via:
a third grating through which a first portion of the light enters from the eye of the user; and
a fourth grating through which a first portion of the light enters from the eye of the user.

9. The eyewear device of claim 2, wherein the eye-tracking device comprises:
a first camera configured to image a retina of the user via the light directed by the waveguide; and
a second camera configured to image a sclera of the eye or a pupil of the eye.

10. The eyewear device of claim 9, wherein the circuitry is further configured to perform stereo imaging of the eye of the user via the first camera and the second camera.

11. The eyewear device of claim 9, further comprising a frame dimensioned to be worn by the user, wherein:
the display assembly comprises a lens that is coupled to the frame;
the first camera is optically coupled to the waveguide; and
the second camera is positioned along a perimeter of the lens or on the frame.

12. The eyewear device of claim 1, wherein the display assembly comprises a set of pixels that are positioned to project the graphical imagery to the eye of the user at a certain angle, wherein the eye-tracking device is positioned proximate to at least one of the pixels such that the light is detected at the certain angle.

13. The eyewear device of claim 12, wherein the set of pixels and the eye-tracking device are positioned along a single optical plane conjugate to the eye of the user.

14. The eyewear device of claim 1, wherein the eye-tracking device comprises a light source that emits the light and a light sensor that detects the light.

15. The eyewear device of claim 1, wherein the circuitry is further configured to predict a change in a gaze of the user based at least in part on:
the graphical imagery projected to the eye of the user at a certain moment in time; and
one or more movements made by the eye of the user around the certain moment in time.

16. The eyewear device of claim 1, wherein the display assembly comprises a scanning display that rasterizes additional light into the graphical imagery for viewing by a user.

17. An artificial-reality system comprising:
an eyewear device comprising:
a display assembly configured to generate graphical imagery for viewing by a user;
an eye-tracking device at least partially integrated into the display assembly; and
circuitry communicatively coupled to the eye-tracking device and configured to track an eye of the user based at least in part on light detected by the eye-tracking device; and
a computing device communicatively coupled to the eyewear device.

18. The artificial-reality system of claim 17, further comprising a waveguide incorporated in the display assembly and configured to:
direct the graphical imagery toward the eye of the user; and
direct the light toward the eye-tracking device.

19. The artificial-reality system of claim 18, further comprising a display device configured to emit additional light used to form the graphical imagery, wherein the waveguide directs the light toward the eye-tracking device and directs the additional light toward the eye of the user.

20. A method comprising:
configuring a display assembly to generate graphical imagery for viewing by a user;
at least partially integrating an eye-tracking device into the display assembly;
communicatively coupling circuitry to the eye-tracking device; and
configuring the circuitry to track an eye of the user based at least in part on light detected by the eye-tracking device.
